(19) United States
(12) Patent Application Publication
(10) Pub. No.: US 2024/0131486 A1
(43) Pub. Date: Apr. 25, 2024

(54) Full-Electric Drive Cementing Control System

(71) Applicant: YANTAI JEREH PETROLEUM EQUIPMENT & TECHNOLOGIES CO., LTD., Yantai, Shandong (CN)

(72) Inventors: Pengyuan ZHANG, Yantai, Shandong (CN); Kai WANG, Yantai, Shandong (CN); Jihua WAN, Yantai, Shandong (CN); Ren LIU, Yantai, Shandong (CN); Jun WANG, Yantai, Shandong (CN); Song ZHANG, Yantai, Shandong (CN); Kaishen LIU, Yantai, Shandong (CN); Shuzhen CUI, Yantai, Shandong (CN); Zhuqing MAO, Yantai, Shandong (CN); Weiwei LIU, Yantai, Shandong (CN)

(73) Assignee: YANTAI JEREH PETROLEUM EQUIPMENT & TECHNOLOGIES CO., LTD., Yantai, Shandong (CN)

(21) Appl. No.: 18/548,048

(22) PCT Filed: Mar. 15, 2022
(86) PCT No.: PCT/CN2022/081191

§ 371 Date: Aug. 24, 2023

(30) Foreign Application Priority Data
Mar. 15, 2021 (CN) 202110279629.4

(51) Int. Cl. B01F 35/221; B01F 25/64; B01F 35/10; B01F 35/21; B01F 35/212; B01F 35/22; F04B 15/02; F04B 17/03; F04D 1/00; F04D 13/12; B01F 101/28

(52) U.S. Cl. CPC B01F 35/221422; B01F 25/64; B01F 35/1452; B01F 35/21111; B01F 35/2112; B01F 35/2113; B01F 35/212; B01F 35/2206; B01F 35/2213; B01F 35/2217; F04B 15/02; F04B 17/03; F04D 1/00; F04D 13/12; B01F 2101/28

(57) ABSTRACT

A full-electric drive cementing control system is disclosed. The system includes: a water supply system for supplying clear water; an ash supply system for supplying dry ash; a slurry mixing system for performing a slurry mixing operation to form slurry; a plunger pump for pumping the slurry to a cementing operation object; and a control assembly for controlling, in response to a received cementing operation instruction, connection of a pipeline between an outlet of the water supply system and an inlet of the slurry mixing system and a pipeline between an outlet of the ash supply system and the inlet of the slurry mixing system, controlling, according to a preset slurry mixing parameter, the slurry mixing system to mix the clear water and the dry ash to form the slurry required for a cementing operation, and controlling, according to a preset perfusion parameter, a driving motor to drive the plunger pump to work, the cementing operation instruction carrying the preset slurry mixing parameter and the preset perfusion parameter.

### CROSS-REFERENCE TO RELATED APPLICATIONS

This application claims priority to Chinese Patent Application No. CN202110279629.4, filed to the China National Intellectual Property Administration on Mar. 16, 2021, entitled “FULL-ELECTRIC DRIVE CEMENTING CONTROL SYSTEM”, the entire contents of which are incorporated herein by reference.

### TECHNICAL FIELD

This application relates to the field of petroleum equipment, and in particular, to a full-electric drive cementing control system.

### BACKGROUND

In a traditional cementing operation process, it is usually necessary for operators to manually operate various components of a cementing device to complete the cementing operation. However, due to the tedious cementing operation process, the manual cementing mode has some problems such as low efficiency, low reliability, and high labor cost.

### SUMMARY

Embodiments of this application provide a full-electric drive cementing control system, in order to solve the problems such as low efficiency, low reliability, and high labor cost in a current cementing operation process.

In order to solve the foregoing problem, the embodiments of this application employ the following technical solutions.

The embodiments of this application provide a full-electric drive cementing control system, including:

a water supply system, configured to supply clear water;

an ash supply system, configured to supply dry ash;

a slurry mixing system, configured to perform a slurry mixing operation to form slurry;

a plunger pump, configured to pump the slurry to a cementing operation object; and

a control assembly, configured to control, in response to a received cementing operation instruction, connection of a pipeline between an outlet of the water supply system and an inlet of the slurry mixing system and a pipeline between an outlet of the ash supply system and the inlet of the slurry mixing system, control, according to a preset slurry mixing parameter, the slurry mixing system to mix the clear water and the dry ash to form the slurry required for a cementing operation, and control, according to a preset perfusion parameter, a driving motor to drive the plunger pump to work, the cementing operation instruction carrying the preset slurry mixing parameter and the preset perfusion parameter.

Optionally, the preset perfusion parameter includes a required perfusion displacement.

The control assembly is configured to obtain a rotation speed of the driving motor, determine a displacement of the plunger pump according to the obtained rotation speed and a preset mapping relationship between motor rotation speeds and plunger pump displacements, and adjust, if the displacement of the plunger pump exceeds the required perfusion displacement, the rotation speed of the driving motor according to the displacement of the plunger pump and the required perfusion displacement, whereby the displacement of the plunger pump reaches the required perfusion displacement.

Optionally, the slurry mixing system includes a slurry mixing device, a first centrifugal pump, and a mass flow detection apparatus.

The mass flow detection apparatus is arranged on a pipeline between an outlet of the first centrifugal pump and a third inlet of a slurry mixing device, and is configured to collect a slurry density in the slurry mixing device.

The control assembly is configured to:

control connection of a pipeline between the outlet of the water supply system and a first inlet of the slurry mixing device, a pipeline between the outlet of the ash supply system and a second inlet of the slurry mixing device, a pipeline between an outlet of the slurry mixing device and an inlet of the first centrifugal pump, and a pipeline between the outlet of the first centrifugal pump and the third inlet of the slurry mixing device;

adjust a stirring speed of the slurry mixing device according to the slurry density in the slurry mixing device and a preset corresponding relationship between slurry densities and stirring speeds; and

control, if the slurry density in the slurry mixing device reaches a preset slurry density, connection of a pipeline between the outlet of the first centrifugal pump and an inlet of the plunger pump, so as to transport the slurry in the slurry mixing device to the plunger pump.

Optionally, the slurry mixing system further includes a first liquid level detection apparatus. The first liquid level detection apparatus is arranged in the slurry mixing device, and is configured to collect liquid level information in the slurry mixing device.

The water supply system is provided with a flow detection apparatus. The flow detection apparatus is arranged on the pipeline between the outlet of the water supply system and the first inlet of the slurry mixing device, and is configured to collect a displacement of clear water supplied to the slurry mixing device.

The control assembly is configured to:

control connection of the pipeline between the outlet of the water supply system and the first inlet of the slurry mixing device so as to supply the clear water to the slurry mixing device;

control, if the liquid level in the slurry mixing device reaches a premixing slurry level or the displacement of the clear water supplied to the slurry mixing device reaches a premixing clear water displacement, disconnection of the pipeline between the outlet of the water supply system and the first inlet of the slurry mixing device, and control connection of the pipeline between the outlet of the ash supply system and the second inlet of the slurry mixing device; and

control, if the slurry density in the slurry mixing device reaches a premixing slurry density, disconnection of the pipeline between the outlet of the ash supply system and the second inlet of the slurry mixing device so as to realize automatic premixing, the preset slurry mixing parameter further including the premixing slurry level, the premixing clear water displacement, and the premixing slurry density.

Optionally, the water supply system includes an external water supply pipeline, a measuring tank, a second centrifugal pump, and a second liquid level detection apparatus. The second liquid level detection apparatus is arranged in the measuring tank, and is configured to collect liquid level information in the measuring tank.

The control assembly is further configured to:

control, before controlling connection of the pipeline between the outlet of the water supply system and the first inlet of the slurry mixing system and the pipeline between the outlet of the ash supply system and the inlet of the slurry mixing system, connection of a pipeline between an outlet of the second centrifugal pump and an inlet of the measuring tank;

adjust a rotation speed of the second centrifugal pump according to the liquid level information in the measuring tank and a first preset measuring liquid level range, so as to transport pre-liquid sucked by the external water supply pipeline from a pre-liquid source to the measuring tank, the cementing operation instruction further carrying a pre-liquid parameter, and the pre-liquid parameter including the first preset measuring liquid level range; and

control connection of a pipeline between an outlet of the measuring tank and the inlet of the plunger pump so as to transport the pre-liquid to the plunger pump.

Optionally, the full-electric drive cementing control system further includes a pressure detection apparatus. The pressure detection apparatus is configured to detect a discharge pressure of the plunger pump.

The control assembly is further configured to:

obtain, before controlling connection of the pipeline between the outlet of the second centrifugal pump and the inlet of the measuring tank, the discharge pressure of the plunger pump which is collected by the pressure detection apparatus; and

adjust, if the discharge pressure of the plunger pump does not reach a preset pressure test value, the driving motor to work according to a difference between the discharge pressure of the plunger pump and the preset pressure test value until the discharge pressure of the plunger pump reaches the preset pressure test value, the cementing operation instruction further carrying a pressure test parameter, and the pressure test parameter including the preset pressure test value.

Optionally, the control assembly is further configured to:

control, after controlling the driving motor to drive the plunger pump to work according to the preset perfusion parameter, connection of the pipeline between the outlet of the second centrifugal pump and the inlet of the measuring tank;

adjust a rotation speed of the second centrifugal pump according to the liquid level information in the measuring tank and a second preset measuring liquid level range, so as to transport displacing liquid sucked by the external water supply pipeline to the measuring tank, the cementing operation instruction further carrying a displacing liquid parameter, and the displacing liquid parameter including the second preset measuring liquid level range; and

control connection of a pipeline between an outlet of the measuring tank and the inlet of the plunger pump so as to transport the displacing liquid to the plunger pump.

Optionally, the control assembly is further configured to:

control, after controlling the driving motor to drive the plunger pump to work according to the preset perfusion parameter, connection of a pipeline between the outlet of the water supply system and an inlet of a target cleaning object so as to clean the target cleaning object by water injection, the target cleaning object including the plunger pump and/or the slurry mixing system;

obtain a liquid density in the target cleaning object; and

control, if the liquid density is less than or equal to a preset density threshold, disconnection of the pipeline between the water supply system and the inlet of the target cleaning object, the cementing operation instruction further carrying a cleaning parameter, and the cleaning parameter including the preset density threshold.

Optionally, the control assembly includes a processor and a frequency converter. The processor is electrically connected to the driving motor, the water supply system, the ash supply system, and the slurry mixing system through the frequency converter.

Optionally, the full-electric drive cementing control system further includes an operation display. The operation display is electrically connected to the control assembly.

The control assembly is further configured to obtain an operation parameter of a target monitoring object, determine whether the target monitoring object is abnormal according to the operation parameter, and transmit, if the target monitoring object is abnormal, warning prompt information to the operation display. The target monitoring object includes one or more of the driving motor, the plunger pump, the water supply system, the ash supply system, and the slurry mixing system.

The operation display is configured to receive and display the warning prompt information transmitted by the control assembly.

At least one of the foregoing technical solutions employed in the embodiments of this application can achieve the following beneficial effects.

A hydraulic system, a diesel engine, and a gearbox in a traditional cementing device are replaced by a driving motor and a control assembly. The control assembly is connected to a water supply system, an ash supply system, a slurry mixing system, and the driving motor, and the control assembly controls the water supply system, the ash supply system, the slurry mixing system, and the driving motor to work respectively according to a preset slurry mixing parameter and a preset perfusion parameter carried in a received cementing operation instruction, thereby realizing full-electric drive automatic control in the cementing process. Compared with a traditional cementing operation mode, the cementing operation is not required to be manually performed, is not affected by a cementing operation environment, and is low in noise, thus further improving the cementing operation efficiency and reliability and saving costs.

### BRIEF DESCRIPTION OF THE DRAWINGS

The accompanying drawings described herein are used to provide a further understanding of this application, and form part of this application. Exemplary embodiments of this application and descriptions thereof are used to explain this application, and do not constitute any inappropriate limitation to this application. In the accompanying drawings:

FIG. 1 is a schematic structural diagram of a full-electric drive cementing control system according to an exemplary embodiment of this application.

FIG. 2 is a schematic structural diagram of a full-electric drive cementing control system according to another exemplary embodiment of this application.

FIG. 3 is a schematic diagram of a cementing operation control flow according to an exemplary embodiment of this application.

FIG. 4 is a schematic diagram of a plunger pump displacement control flow according to an exemplary embodiment of this application.

FIG. 5 is a schematic diagram of an automatic slurry mixing control flow according to an exemplary embodiment of this application.

FIG. 6 is a schematic diagram of a cementing operation control flow according to another exemplary embodiment of this application.

### DETAILED DESCRIPTION

To clearly state the objects, technical solutions, and advantages of this application, the technical solutions of this application will be clearly and completely described below with reference to specific embodiments of this application and the accompanying drawings. Apparently, the described embodiments are only some embodiments rather than all the embodiments of this application. All other embodiments obtained by a person of ordinary skill in the art based on the embodiments of this application without creative efforts shall fall within the protection scope of this application.

In the specification and claims of this application, the terms “first”, “second”, and so on are intended to distinguish similar objects but do not necessarily indicate a specific order or sequence. It is to be understood that such used data is interchangeable where appropriate so that the embodiments of this application can be implemented in an order other than those illustrated or described here. In addition, “and/or” in the specification and claims represents at least one of the connected objects, and the character “I” generally identifies that the associated objects are in an “or” relationship.

The following describes the technical solution provided in each embodiment of this application in detail with reference to the accompanying drawings.

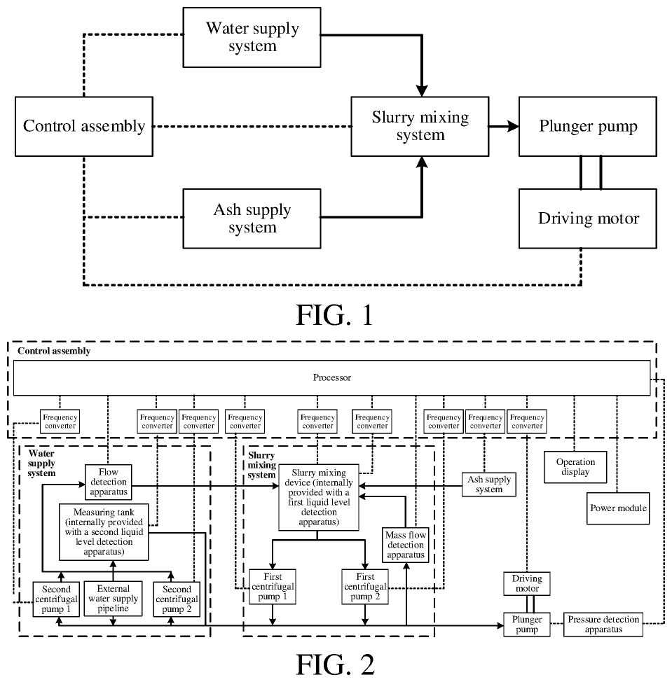

Referring to FIG. 1 and FIG. 2, the embodiments of this application provide a full-electric drive cementing control system. The system includes a water supply system, an ash supply system, a slurry mixing system, a plunger pump, a driving motor, and a control assembly.

The water supply system may be configured to supply clear water, and the ash supply system may be configured to supply dry ash. A first inlet of the slurry mixing system is connected to an outlet of the water supply system, and a second inlet of the slurry mixing system is connected to an outlet of the ash supply system, so as to mix the clear water supplied by the water supply system and the dry ash supplied by the ash supply system to form slurry. The plunger pump is connected to an outlet of the slurry mixing system, so as to pump the slurry outputted by the slurry mixing system to a cementing operation object. The driving motor is in transmission connection with the plunger pump, so as to drive the plunger pump to work. Specifically, the driving motor may be connected to the plunger pump through a transmission assembly such as a transmission shaft.

The control assembly is electrically connected to the driving motor, the water supply system, the ash supply system, and the slurry mixing system respectively, so as to control the water supply system, the ash supply system, the slurry mixing system, and the driving motor to work, thus realizing the automatic control effect of the whole cementing operation flow.

It is to be noted that solid lines in FIG. 1 and FIG. 2 represent pipeline connection, and dotted lines represent electrical connection.

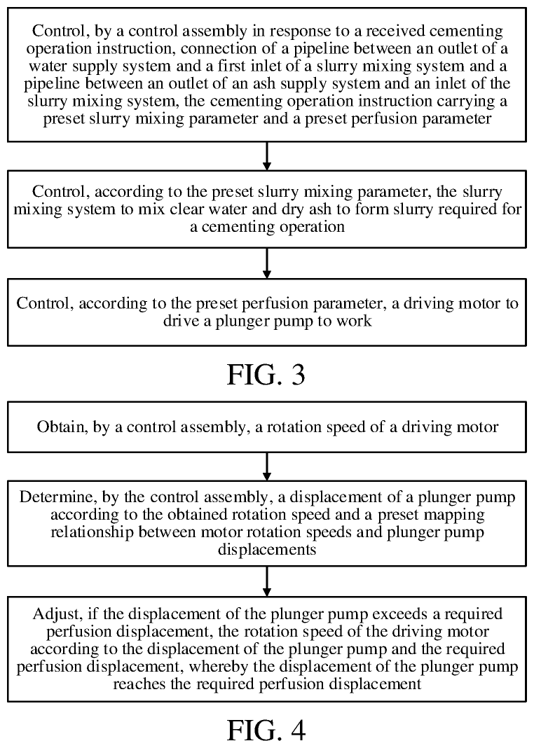

Specifically, as shown in FIG. 3, the control assembly is configured to control, in response to a received cementing operation instruction, connection of a pipeline between an outlet of the water supply system and a first inlet of the slurry mixing system and a pipeline between an outlet of the ash supply system and the inlet of the slurry mixing system, control, according to a preset slurry mixing parameter, the slurry mixing system to mix the clear water and the dry ash to form the slurry required for a cementing operation, and control, according to a preset perfusion parameter, a driving motor to drive the plunger pump to work. The cementing operation instruction carries the preset slurry mixing parameter and the preset perfusion parameter.

It is to be understood that according to the full-electric drive cementing control system provided in the embodiments of this application, a hydraulic system, a diesel engine, and a gearbox in a traditional cementing device are replaced by a driving motor and a control assembly. The control assembly is connected to a water supply system, an ash supply system, a slurry mixing system, and the driving motor, and the control assembly controls the water supply system, the ash supply system, the slurry mixing system, and the driving motor to work respectively according to a preset slurry mixing parameter and a preset perfusion parameter carried in a received cementing operation instruction, thereby realizing full-electric drive automatic control in the cementing process. Compared with a traditional cementing operation mode, the cementing operation is not required to be manually performed, is not affected by a cementing operation environment, and is low in noise, thus further improving the cementing operation efficiency and reliability and saving costs.

In order to accurately control the displacement of the plunger pump and better meet the cementing requirements, in a preferred solution, the preset perfusion parameter may include a required perfusion displacement. The control assembly may control the driving motor according to the required perfusion displacement, so as to drive the plunger pump to pump slurry to a cementing operation object according to the required perfusion displacement, thus realizing the automatic displacement control of the plunger pump.

Specifically, as shown in FIG. 4, the control assembly obtains a rotation speed of the driving motor, and determines a displacement of the plunger pump according to the obtained rotation speed and a preset mapping relationship between motor rotation speeds and plunger pump displacements. If the displacement of the plunger pump exceeds the required perfusion displacement, the rotation speed of the driving motor is adjusted according to the displacement of the plunger pump and the required perfusion displacement, whereby the displacement of the plunger pump reaches the required perfusion displacement. The preset mapping relationship between motor rotation speeds and plunger pump displacements may be determined by experimental analysis.

For example, the preset mapping relationship between motor rotation speeds and plunger pump displacements is y=ax, where y represents the displacement of the plunger pump, x represents the rotation speed of the driving motor, and a represents a preset displacement coefficient. If the displacement of the plunger pump is less than the required perfusion displacement, the rotation speed of the driving motor is increased to increase the rotation speed of the plunger pump, thus increasing the displacement of the plunger pump. If the displacement of the plunger pump is greater than the required perfusion displacement, the rotation speed of the driving motor is reduced to reduce the rotation speed of the plunger pump, thus reducing the displacement of the plunger pump.

In the embodiments of this application, the slurry mixing system may have any suitable structure. Referring to FIG. 2, in an alternative, the slurry mixing system includes a slurry mixing device, a first centrifugal pump, and a mass flow detection apparatus. A first inlet of the slurry mixing device is connected to the outlet of the water supply system through a pipeline. A second inlet of the slurry mixing device is connected to the outlet of the ash supply system through a pipeline. A third inlet of the slurry mixing device is connected to an outlet of the first centrifugal pump through a pipeline. An outlet of the slurry mixing device is connected to an inlet of the first centrifugal pump through a pipeline. The outlet of the first centrifugal pump is connected to an inlet of the plunger pump through a pipeline.

More specifically, the slurry mixing device includes a mixer and a slurry mixing tank. A first inlet of the mixer serves as the first inlet of the slurry mixing device and is connected to the outlet of the water supply system through a pipeline. A second inlet of the mixer serves as the second inlet of the slurry mixing device and is connected to the outlet of the ash supply system through a pipeline. A third inlet of the mixer serves as the third inlet of the slurry mixing device and is connected to the outlet of the first centrifugal pump through a pipeline. An outlet of the mixer is connected to an inlet of the slurry mixing tank. An outlet of the slurry mixing tank serves as the outlet of the slurry mixing device and is connected to the inlet of the first centrifugal pump through a pipeline. In a slurry mixing process, the mixer may mix the clear water supplied by the water supply system and the dry ash supplied by the ash supply system, and then transport the mixture to the slurry mixing tank for re-mixing.

It is to be noted that the mixer and the slurry mixing tank may be integrated in practical application.

The mass flow detection apparatus is arranged on a pipeline between the outlet of the first centrifugal pump and the third inlet of the slurry mixing device, and is configured to collect a slurry density in the slurry mixing device. The control assembly is electrically connected to the mass flow detection apparatus, and may realize the effect of automatic slurry mixing control by controlling the connection and disconnection of the pipeline between the slurry mixing device, the first centrifugal pump, and the plunger pump and a stirrer of the slurry mixing device.

Specifically, the control assembly controls connection of a pipeline between the outlet of the water supply system and the first inlet of the slurry mixing device so as to supply clear water to the slurry mixing device, and controls connection of a pipeline between the outlet of the ash supply system and the second inlet of the slurry mixing device so as to supply dry ash to the slurry mixing device. The control assembly further controls the stirrer of the slurry mixing device to rotate so as to mix the clear water and the dry ash, and controls connection of a pipeline between the outlet of the slurry mixing device and the inlet of the first centrifugal pump and connection of a pipeline between the outlet of the first centrifugal pump and the third inlet of the slurry mixing system, whereby the slurry in the slurry mixing device is returned to the slurry mixing device via the first centrifugal pump for cyclic mixing. The slurry density collected by the mass flow detection apparatus is the slurry density in the slurry mixing device.

In the mixing process, the control assembly may adjust a stirring speed of the slurry mixing device according to the slurry density in the slurry mixing device and a preset corresponding relationship between slurry densities and stirring speeds, thus realizing stepless speed regulation of the slurry mixing device, whereby the density in the slurry mixing device is more uniform, and the cementing quality is further enhanced. When the slurry density in the slurry mixing device reaches a preset slurry density, connection of a pipeline between the outlet of the first centrifugal pump and the inlet of the plunger pump is controlled, so as to transport the slurry in the slurry mixing device to the plunger pump. The plunger pump pumps the slurry to the cementing operation object for cementing operation. The preset slurry mixing parameter includes the preset slurry density.

It is to be noted that a valve is arranged on the pipeline between the slurry mixing device, the first centrifugal pump, and the plunger pump in practical application. The control assembly may realize the connection and disconnection of the pipeline by controlling the on and off of the valve.

In addition, the number of first centrifugal pumps may be determined as needed. In a more preferred solution, there may be at least two first centrifugal pumps such as a first centrifugal pump 1 and a first centrifugal pump 2 shown in FIG. 2. In this way, under the condition that the at least two first centrifugal pumps are normal, one of the first centrifugal pumps may undertake a secondary circulation function of the slurry in the slurry mixing device, and the other first centrifugal pump may undertake the function of transporting the slurry in the slurry mixing device to the plunger pump. Under the condition that any one first centrifugal pump fails, the normal first centrifugal pump undertakes both the secondary circulation function of the slurry in the slurry mixing device and the function of transporting the slurry in the slurry mixing device to the plunger pump.

For example, as shown in FIG. 2, under the condition that both the first centrifugal pump 1 and the first centrifugal pump 2 are normal, connection of a pipeline between the outlet of the slurry mixing device and an inlet of the first centrifugal pump 1 and connection of a pipeline between an outlet of the first centrifugal pump 1 and the third inlet of the slurry mixing system may be controlled, whereby the slurry in the slurry mixing device is returned to the slurry mixing device via the first centrifugal pump 1 for cyclic mixing. When the slurry density in the slurry mixing device reaches a preset slurry density, connection of a pipeline between an outlet of the first centrifugal pump 2 and the inlet of the plunger pump is controlled, so as to transport the slurry in the slurry mixing device to the plunger pump. The plunger pump pumps the slurry to the cementing operation object for cementing operation.

Under the condition that the first centrifugal pump 1 fails, connection of a pipeline between the outlet of the slurry mixing device and an inlet of the first centrifugal pump 2 and connection of a pipeline between the outlet of the first centrifugal pump 2 and the third inlet of the slurry mixing system may be controlled, whereby the slurry in the slurry mixing device is returned to the slurry mixing device via the first centrifugal pump 2 for cyclic mixing. When the slurry density in the slurry mixing device reaches a preset slurry density, connection of a pipeline between an outlet of the first centrifugal pump 2 and the inlet of the plunger pump is controlled, so as to transport the slurry in the slurry mixing device to the plunger pump. The plunger pump pumps the slurry to the cementing operation object for cementing operation.

It is to be understood that with the foregoing solution, the first centrifugal pumps may be mutually standby. When any first centrifugal pump fails, the normal working of the automatic slurry mixing flow can be ensured, thus ensuring the normal progress of the whole cementing operation and improving the reliability of the full-electric drive cementing control system.

Certainly, it is to be understood by those skilled in the art that in other alternatives, the number of first centrifugal pumps may also be increased or reduced according to actual needs.

In order to ensure the stability of density measurement and improve the accuracy of data collected by the mass flow detection apparatus, the mass flow detection apparatus may further collect a flow velocity of the pipeline, and the control assembly may also adjust the rotation speed of the first centrifugal pump according to the flow velocity collected by the mass flow detection apparatus.

In order to ensure that the liquid level in the slurry mixing device is maintained at a reasonable value to avoid tank overflow or tank emptiness in the slurry mixing device, in a more preferred solution, as shown in FIG. 2, the slurry mixing system may further include a first liquid level detection apparatus. The first liquid level detection apparatus is arranged in the slurry mixing device, and is configured to collect liquid level information in the slurry mixing device. Specifically, the first liquid level detection apparatus may be any component with a liquid level detection function, and may be selected according to actual needs. The embodiments of this application are not limited thereto. For example, the first liquid level detection apparatus may be a liquid level meter.

Accordingly, the preset slurry mixing parameter may further include a preset slurry mixing liquid level range. The control assembly is further electrically connected to the first liquid level detection apparatus, and may control a rotation speed of a circulating pump and/or a rotation speed of a perfusion pump according to the liquid level information collected by the first liquid level detection apparatus and the preset slurry mixing liquid level range.

For example, if the liquid level in the slurry mixing device exceeds an upper limit of the preset slurry mixing liquid level range, the control assembly reduces the rotation speed of the first centrifugal pump, thereby reducing the slurry entry amount of the slurry mixing device. If the liquid level in the slurry mixing device is smaller than a lower limit of the preset slurry mixing liquid level range, the control assembly increases the rotation speed of the first centrifugal pump, thereby increasing the slurry entry amount of the slurry mixing device.

Certainly, in other implementations, when the liquid level in the mixing device exceeds the upper limit of the preset slurry mixing liquid level range, the control assembly may also adjust the opening degree of a water valve at the first inlet of the slurry mixing device, thus achieving the effect of adjusting the liquid level in the slurry mixing device.

In order to improve the slurry mixing efficiency and further improve the uniformity of the slurry density in the slurry mixing device, in a more preferred solution, the automatic slurry mixing control flow includes a premixing control flow and a slurry mixing control flow. The preset slurry mixing parameter further includes a premixing slurry level, a premixing clear water displacement, and a premixing slurry density for the premixing control flow. The control assembly may control the slurry mixing device to premix the slurry according to the premixing slurry level, the premixing clear water displacement, and the premixing slurry density, and control the slurry mixing device to re-mix the slurry after meeting premixing requirements.

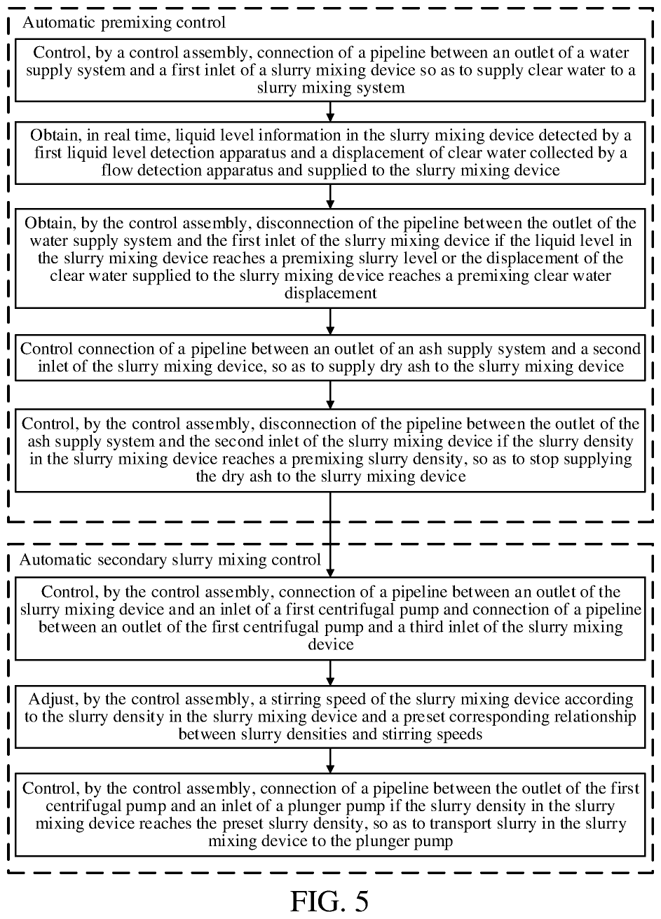

Specifically, the full-electric drive cementing control system further includes a flow detection apparatus. The flow detection apparatus is arranged on the pipeline between the outlet of the water supply system and the first inlet of the slurry mixing device, and is configured to collect a displacement of clear water supplied to the slurry mixing device. Accordingly, as shown in FIG. 5, the premixing slurry control flow specifically includes the following steps. The control assembly controls connection of the pipeline between the outlet of the water supply system and the first inlet of the slurry mixing device so as to supply clear water to the slurry mixing system, and obtains, in real time, the liquid level information in the slurry mixing device detected by the first liquid level detection apparatus and the displacement of clear water collected by the flow detection apparatus and supplied to the slurry mixing device. If the liquid level in the slurry mixing device reaches the premixing slurry level or the displacement of the clear water supplied to the slurry mixing device reaches the premixing clear water displacement, the control assembly controls disconnection of the pipeline between the outlet of the water supply system and the first inlet of the slurry mixing device, and controls connection of the pipeline between the outlet of the ash supply system and the second inlet of the slurry mixing device, so as to supply dry ash to the slurry mixing device. At this moment, the slurry density in the slurry mixing device is gradually increased. If the slurry density in the slurry mixing device reaches the premixing slurry density, the control assembly controls disconnection of the pipeline between the outlet of the ash supply system and the second inlet of the slurry mixing device, so as to stop supplying the dry ash to the slurry mixing device. After the end of the premixing flow, the control assembly initiates the slurry mixing control flow.

As shown in FIG. 5, the secondary slurry mixing control flow includes the following steps. The control assembly controls connection of the pipeline between the outlet of the slurry mixing device and the inlet of the first centrifugal pump and connection of the pipeline between the outlet of the first centrifugal pump and the third inlet of the slurry mixing device. At this moment, the slurry in the slurry mixing device is returned to the slurry mixing device via the first centrifugal pump for cyclic mixing. The slurry density collected by the mass flow detection apparatus is the slurry density in the slurry mixing device. Meanwhile, the control assembly adjusts a stirring speed of the slurry mixing device according to the slurry density in the slurry mixing device and a preset corresponding relationship between slurry densities and stirring speeds, whereby the slurry density in the slurry mixing device reaches the preset slurry density. If the slurry density in the slurry mixing device reaches the preset slurry density, the control assembly controls connection of the pipeline between the outlet of the first centrifugal pump and the inlet of the plunger pump, so as to transport the slurry in the slurry mixing device to the plunger pump. The plunger pump pumps the slurry to the cementing operation object for cementing.

In the embodiments of this application, the water supply system may have any suitable structure. Referring to FIG. 2, in an alternative, the water supply system includes a measuring tank, a second centrifugal pump, an external water supply pipeline, and a second liquid level detection apparatus. An inlet of the second centrifugal pump is connected to an outlet of the measuring tank through a pipeline. An outlet of the second centrifugal pump is connected to the first inlet of the slurry mixing system and an inlet of the measuring tank through a pipeline respectively. The external water supply pipeline is further connected to the inlet of the second centrifugal pump and the inlet of the measuring tank respectively.

The second liquid level detection apparatus is arranged in the measuring tank, and is configured to collect liquid level information in the measuring tank. The control assembly is electrically connected to the second liquid level detection apparatus. In practical application, the second liquid level detection apparatus may be any component with a liquid level detection function, and may be selected according to actual needs. The embodiments of this application are not specifically limited thereto. For example, the second liquid level detection apparatus may be a liquid level meter.

The cementing operation instruction further carries a pre-liquid parameter. The control assembly may also control the water supply system to transport pre-liquid to the plunger pump according to the pre-liquid parameter before slurry mixing, and the plunger pump pumps the pre-liquid to the cementing operation object, thus realizing the effect of automatic pre-liquid control.

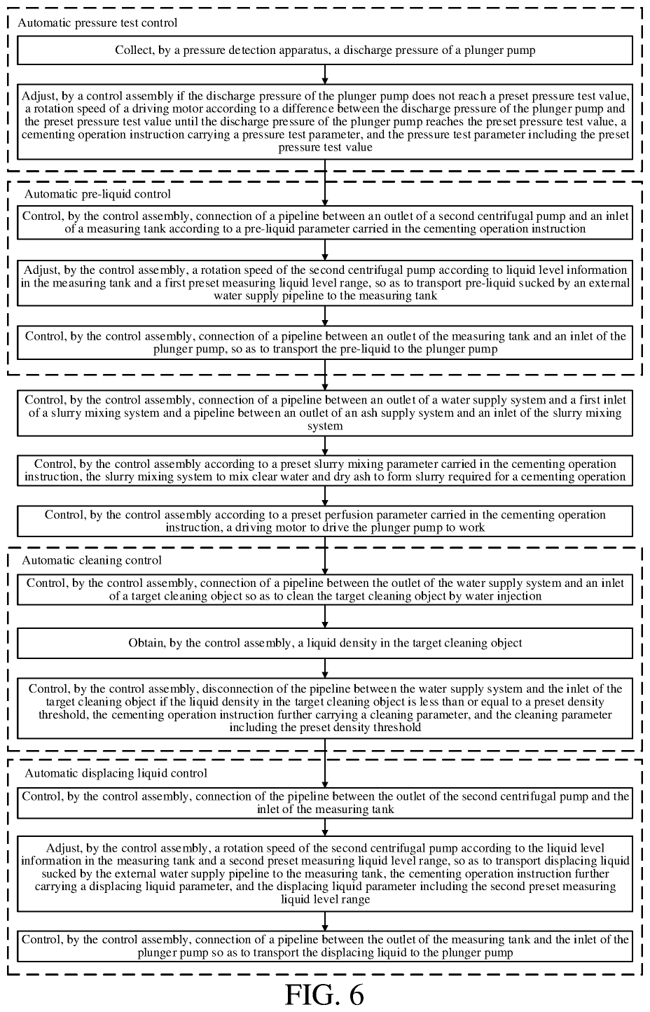

Specifically, the pre-liquid parameter includes a first preset measuring liquid level range. The external water supply pipeline may suck the pre-liquid from a pre-liquid source. As shown in FIG. 6, before controlling connection of the pipeline between the outlet of the water supply system and the first inlet of the slurry mixing system and the pipeline between the outlet of the ash supply system and the inlet of the slurry mixing system, the control assembly further controls connection of a pipeline between the outlet of the second centrifugal pump and the inlet of the measuring tank, adjusts a rotation speed of the second centrifugal pump according to the liquid level information in the measuring tank and the first preset measuring liquid level range, so as to transport the pre-liquid sucked by the external water supply pipeline to the measuring tank, and controls connection of a pipeline between an outlet of the measuring tank and the inlet of the plunger pump, so as to transport the pre-liquid to the plunger pump.

For example, if the liquid level in the measuring tank exceeds an upper limit of the first preset measuring liquid level range, the control assembly increases the rotation speed of the second centrifugal pump, thus increasing the amount of pre-liquid entering the measuring tank until the liquid level in the measuring tank is within the first preset measuring range. If the liquid level in the measuring tank is smaller than a lower limit of the first preset measuring liquid level range, the control assembly reduces the rotation speed of the second centrifugal pump, thus reducing the amount of pre-liquid entering the measuring tank until the liquid level in the measuring tank is within the first preset measuring range.

Further, in order to meet the requirements of pre-liquid operation, the pre-liquid parameter may further include a preset pre-liquid displacement. Accordingly, the control assembly may further adjust the rotation speed of the driving motor according to a pre-liquid displacement of the plunger pump and the preset pre-liquid displacement until the pre-liquid displacement of the plunger pump reaches the preset pre-liquid displacement.

It is to be understood that the automatic pre-liquid control effect may be achieved through the foregoing solution, and in the process of automatic pre-liquid control, the rotation speed of the second centrifugal pump may be adjusted according to the liquid level information in the measuring tank and the first preset measuring liquid level range, whereby the liquid level in the measuring tank can be kept constant, and the cementing quality can be improved.

It is to be noted that different properties of pre-liquid may be used in the actual cementing operation process, and the control assembly may further automatically switch a pre-liquid supply pipeline according to the properties of the pre-liquid used. For example, the control assembly may further control connection of a pipeline between the inlet of the measuring tank and the external water supply pipeline, so as to directly transport the pre-liquid sucked by the external water supply pipeline to the measuring tank.

In order to ensure the stability of discharge pressure of the plunger pump and avoid safety production accidents such as personal injury and mechanical failure caused by pipeline collapse, the cementing operation instruction further carries a pressure test parameter. The control assembly may also test the discharge pressure of the plunger pump according to the pressure test parameter before the pre-liquid operation. Specifically, the pressure test parameter includes a preset pressure test value. The full-electric drive cementing control system further includes a pressure detection apparatus, which is configured to collect the discharge pressure of the plunger pump. As shown in FIG. 6, if the discharge pressure of the plunger pump does not reach the preset pressure test value, the control assembly adjusts the rotation speed of the driving motor according to a difference between the discharge pressure of the plunger pump and the preset pressure test value until the discharge pressure of the plunger pump reaches the preset pressure test value.

For example, if the difference between the discharge pressure of the plunger pump and the preset pressure test value is large, the rotation speed of the driving motor is increased to increase the rotation speed of the plunger pump, thus increasing the discharge pressure of the plunger pump. If the difference between the discharge pressure of the plunger pump and the preset pressure test value is small, the rotation speed of the driving motor is reduced to reduce the rotation speed of the plunger pump, thus reducing the discharge pressure of the plunger pump. After the discharge pressure of the plunger pump reaches the preset pressure test value, the driving motor is controlled to stop rotating, and the automatic pre-liquid control flow is initiated. Therefore, the effect of automatic pressure test control can be achieved.

Further, the cementing operation instruction also carries a displacing liquid parameter. The control assembly may also control the water supply system to transport displacing liquid to the plunger pump according to the displacing liquid parameter after slurry mixing, and the plunger pump pumps the displacing liquid to the cementing operation object, thus realizing the effect of automatic displacing liquid control.

Specifically, the displacing liquid parameter includes a second preset measuring liquid level range. The external water supply pipeline may suck the displacing liquid from a displacing liquid source. As shown in FIG. 6, before controlling the driving motor to drive the plunger pump according to the preset perfusion parameter, the control assembly further controls connection of a pipeline between the outlet of the second centrifugal pump and the inlet of the measuring tank, adjusts a rotation speed of the second centrifugal pump according to the liquid level information in the measuring tank and the second preset measuring liquid level range, so as to transport the displacing liquid sucked by the external water supply pipeline to the measuring tank, and controls connection of a pipeline between an outlet of the measuring tank and the inlet of the plunger pump, so as to transport the displacing liquid to the plunger pump.

For example, if the liquid level in the measuring tank exceeds an upper limit of the second preset measuring liquid level range, the control assembly increases the rotation speed of the second centrifugal pump, thus increasing the amount of displacing liquid entering the measuring tank until the liquid level in the measuring tank is within the second preset measuring range. If the liquid level in the measuring tank is smaller than a lower limit of the second preset measuring liquid level range, the control assembly reduces the rotation speed of the second centrifugal pump, thus reducing the amount of displacing liquid entering the measuring tank until the liquid level in the measuring tank is within the second preset measuring range.

In addition, the number of second centrifugal pumps may be determined as needed in practical application. In a more preferred solution, there may be at least two second centrifugal pumps such as a second centrifugal pump 1 and a second centrifugal pump 2 shown in FIG. 2. In this way, if the at least two second centrifugal pumps are normal in the automatic slurry mixing process, one of the second centrifugal pumps may transport clear water to the measuring tank, and the other second centrifugal pump may transport the clear water in the measuring tank to the slurry mixing system. If one of the second centrifugal pumps fails, the clear water may be directly supplied to the measuring tank by the external water supply pipeline, and the normal second centrifugal pump may transport the clear water in the measuring tank to the slurry mixing system, or the normal centrifugal pump may undertake the work of supplying water to both the measuring tank and the slurry mixing device.

If the at least two second centrifugal pumps are normal in the automatic pre-liquid or automatic displacing liquid flow, one of the second centrifugal pumps may transport pre-liquid or displacing liquid to the measuring tank. If one of the second centrifugal pumps fails, the normal second centrifugal pump may transport the pre-liquid or the displacing liquid to the measuring tank.

It is to be understood that with the foregoing solution, the second centrifugal pumps may be mutually standby. When any second centrifugal pump fails, the normal working of the automatic slurry mixing flow, automatic pre-liquid flow, and the automatic displacing liquid flow can be ensured, thus ensuring the normal progress of the whole cementing operation and improving the reliability of the full-electric drive cementing control system.

Further, the cementing operation instruction also carries a cleaning parameter. The control assembly may also control the water supply system to supply clear water to a target cleaning object according to the cleaning parameter after the automatic slurry mixing flow, so as to clean the target cleaning object, thereby avoiding problems such as slurry solidification or caking in the target cleaning object. The target cleaning object may include at least one of the plunger pump, the slurry mixing system, a pipeline between the water supply system and the plunger pump, a pipeline between the water supply system and the slurry mixing system, and a pipeline between the slurry mixing system and the plunger pump.

Specifically, as shown in FIG. 6, the cleaning parameter may include a preset density threshold. The control assembly may control connection of a pipeline between the outlet of the water supply system and an inlet of the target cleaning object so as to clean the target cleaning object by water injection, and obtain a liquid density in the target cleaning object. If the liquid density in the target cleaning object is less than or equal to the preset density threshold, the control assembly controls disconnection of the pipeline between the water supply system and the inlet of the target cleaning object. Therefore, the effect of automatic cleaning control for the target cleaning object is achieved.

It is to be noted that the automatic cleaning flow may be carried out before, after, or during the automatic displacing liquid flow in practical application. Preferably, the automatic cleaning flow is carried out before the automatic displacing liquid flow.

In the embodiments of this application, the control assembly may have any suitable structure. In order to realize accurate control of each flow, in a more preferred solution, as shown in FIG. 2, the control assembly may include a processor and a frequency converter. The processor is electrically connected to the driving motor, the water supply system, the ash supply system, and the slurry mixing system through the frequency converter. Therefore, the processor may control the driving motor, the water supply system, the ash supply system, and the slurry mixing system by frequency conversion through the frequency converter, so as to better meet the needs of cementing operation.

In order to facilitate operators to know the cementing operation state in time, as shown in FIG. 2, the full-electric drive cementing control system further includes an operation display.

The operation display is electrically connected to the control assembly.

The control assembly is further configured to obtain an operation parameter of a target monitoring object, determine whether the target monitoring object is abnormal according to the operation parameter, and transmit, if the target monitoring object is abnormal, warning prompt information to the operation display. The operation display is configured to receive and display the warning prompt information transmitted by the control assembly.

The target monitoring object includes one or more of the driving motor, the plunger pump, the water supply system, the ash supply system, and the slurry mixing system. The operation parameter of the driving motor may include, for example but not limited to, rotation speed, torque, power, temperature, voltage, current, amplitude, displacement, operation time, and the like. The operation parameter of the plunger pump may include, for example but not limited to, discharge pressure, displacement, density of discharged slurry, and the like. The operation parameters of the water supply system, the ash supply system, and the slurry mixing system may include, for example, rotation speeds of the respective pumps, on and off states and opening degrees of the valves on the pipeline, and the like.

It is to be understood that the foregoing solution can achieve the effect of automatic fault diagnosis and warning in the cementing operation process.

Certainly, it is to be understood that the control assembly may also transmit the operation parameter of the target monitoring object to the operation display, and the operation display receives and displays the operation parameter of the target monitoring object.

In addition, the operation display may also display a cementing operation interface. An operator may input relevant parameters of the cementing operation through the cementing operation interface, such as the preset slurry mixing parameter, the preset perfusion parameter, the pre-liquid parameter, the displacing liquid parameter, the pressure test parameter, and the cleaning parameter. The operation display generates a cementing operation instruction according to the parameters inputted by the operator, and transmits the cementing operation instruction to the control assembly.

Further, the operation display also has a remote control function. Specifically, the operation display may be in communicative connection with a remote service platform, so as to receive a cementing operation instruction transmitted by the remote service platform and transmit the cementing operation instruction to the control assembly.

In the embodiments of this application, the control assembly may be connected to an external power supply, and the external power supply provides electric energy required by the operation of the full-electric drive cementing control system. In a more preferred solution, the full-electric drive cementing control system provided by the embodiments of this application may further include a power module. The power module is electrically connected to the control assembly. The power module provides electric energy required by the operation of the full-electric drive cementing control system. For example, as shown in FIG. 2, the power module is electrically connected to the processor in the control assembly.

In the embodiments of this application, the power module may have any suitable structure. In an alternative, the power module may include a battery pack (not shown). The battery pack may be detachably connected to the control assembly through a connector, thereby enabling rapid replacement of the battery pack or addition of the battery pack to provide longer operating power for the full-electric drive cementing control system. Therefore, by supplying power through the battery pack, there is no need to connect external lines such as power cables, thus reducing the preparatory work of the cementing operation, simplifying the cementing operation flow, improving the cementing operation efficiency and the flexibility of the full-electric drive cementing control system, and also reducing the requirements of the full-electric drive cementing control system on road conditions.

In a more preferred solution, the power module may further include a first power switch and a second power switch (not shown). The control assembly is electrically connected to the external power supply through the first power switch. The second power switch is arranged between the control assembly and the battery pack. Therefore, by controlling the on-off of the first power switch and the second power switch, the power mode may be switched, thus ensuring that the full-electric drive cementing control system can adapt to various working conditions on the operation site, and reducing the restriction on the power supply conditions on the operation site.

Specifically, in order to realize power supply from the external power supply, the first power switch may be controlled to be turned on while the second power switch may be controlled to be turned off. In order to realize power supply from the battery pack, the second power switch may be controlled to be turned on while the first power switch may be controlled to be turned off. In order to realize power supply from both the battery pack and the external power supply, both the first power switch and the second power switch may be controlled to be turned on.

It is to be noted that under the condition of power supply from the battery pack, the battery pack with appropriate capacity may be selected according to the workload and working time of the cementing operation, so as to meet a complete cementing operation. In addition, when the full-electric drive cementing control system is not working, the battery pack may be electrically connected to the external power supply, and the external power supply charges the battery pack.

The foregoing descriptions are merely preferred embodiments of this application and are not intended to limit the protection scope of this application. Any modification, equivalent replacement, or improvement made without departing from the spirit and principle of this application should fall within the protection scope of this application.

The system, the apparatus, the module, or the unit described in the foregoing embodiments may be specifically implemented by a computer chip or an entity, or implemented by a product having a certain function. A typical implementation device is one or a combination of a programmable logic controller (PLC), a control substrate, a national instruments (NI) virtual instrument, a central processing unit (CPU), and the like.

It is also to be noted that the term “include,” “comprise,” or their any other variants is intended to cover a non-exclusive inclusion, whereby a process, a method, a product, or a device that includes a series of elements not only includes such elements, but also includes other elements not expressly listed, or further includes elements inherent to such a process, method, product, or device. Unless otherwise specified, an element limited by “include a/an . . . ” does not exclude other same elements existing in the process, the method, the article, or the device that includes the element.

The embodiments of this specification are all described in a progressive manner. For same or similar parts in the embodiments, reference is made to these embodiments, and descriptions of each embodiment focus on a difference from other embodiments. Especially, a system embodiment is basically similar to a method embodiment, and therefore is described briefly. For related parts, reference may be made to partial descriptions in the method embodiment.

1. A full-electric drive cementing control system, comprising:
a water supply system, configured to supply liquid water;
an ash supply system, configured to supply dry ash;
a slurry mixing system, configured to perform a slurry mixing operation to form a slurry;
a plunger pump, configured to pump the slurry to a cementing operation target; and
a control assembly, configured to control, in response to a received cementing operation instruction, a connection of a pipeline between an outlet of the water supply system and an inlet of the slurry mixing system and a pipeline between an outlet of the ash supply system and the inlet of the slurry mixing system, to control, according to a preset slurry mixing parameter, the slurry mixing system to mix the liquid water and the dry ash to form the slurry required for a cementing operation, and to control, according to a preset perfusion parameter, a driving motor to drive the plunger pump, the cementing operation instruction carrying the preset slurry mixing parameter and the preset perfusion parameter.

2. The full-electric drive cementing control system according to claim 1, wherein:
the preset perfusion parameter comprises a required perfusion displacement; and
the control assembly is configured to obtain a rotation speed of the driving motor, to determine a displacement of the plunger pump according to the obtained rotation speed and a preset mapping relationship between motor rotation speeds and plunger pump displacements, and to adjust, if the displacement of the plunger pump exceeds the required perfusion displacement, the rotation speed of the driving motor according to the displacement of the plunger pump and the required perfusion displacement, whereby the displacement of the plunger pump reaches the required perfusion displacement.

3. The full-electric drive cementing control system according to claim 1, wherein:
the slurry mixing system comprises a slurry mixing tank, a first centrifugal pump, and a mass flow detection apparatus;
the mass flow detection apparatus is arranged on a pipeline between an outlet of the first centrifugal pump and a third inlet of a slurry mixing device of the slurry mixing system, and is configured to measure a slurry density in the slurry mixing device; and
the control assembly is configured to:
control connection of a pipeline between the outlet of the water supply system and a first inlet of the slurry mixing device, a pipeline between the outlet of the ash supply system and a second inlet of the slurry mixing device, and a pipeline between an outlet of the slurry mixing device and an inlet of the first centrifugal pump;
adjust a stirring speed of the slurry mixing device according to the slurry density in the slurry mixing device and a preset corresponding relationship between slurry densities and stirring speeds; and
control, if the slurry density in the slurry mixing device reaches a preset slurry density threshold, a connection of a pipeline between the outlet of the first centrifugal pump and an inlet of the plunger pump, so as to transport the slurry in the slurry mixing device to the plunger pump.

4. The full-electric drive cementing control system according to claim 3, wherein:
the slurry mixing system further comprises a first liquid level detection apparatus, the first liquid level detection apparatus being arranged in the slurry mixing device and configured to collect liquid level information in the slurry mixing device; and
the water supply system is provided with a flow detection apparatus, the flow detection apparatus being arranged on the pipeline between the outlet of the water supply system and the first inlet of the slurry mixing device and configured to collect a displacement of the liquid water supplied to the slurry mixing device; and
the control assembly is configured to:
control a connection of the pipeline between the outlet of the water supply system and the first inlet of the slurry mixing device so as to supply the liquid water to the slurry mixing device;
control, if the liquid level in the slurry mixing device reaches a premixing slurry level or the displacement of the clear water supplied to the slurry mixing device reaches a premixing water displacement, a disconnection of the pipeline between the outlet of the water supply system and the first inlet of the slurry mixing device, and control a connection of the pipeline between the outlet of the ash supply system and the second inlet of the slurry mixing device; and
control, if the slurry density in the slurry mixing device reaches a premixing slurry density, a disconnection of the pipeline between the outlet of the ash supply system and the second inlet of the slurry mixing device so as to realize automatic premixing, the preset slurry mixing parameter further comprising the premixing slurry level, the premixing water displacement, and the premixing slurry density.

5. The full-electric drive cementing control system according to claim 1, wherein:
the water supply system comprises an external water supply pipeline, a measuring tank, a second centrifugal pump, and a second liquid level detection apparatus, the second liquid level detection apparatus being arranged in the measuring tank and configured to measure liquid level information in the measuring tank; and
the control assembly is further configured to:
control, before controlling connection of the pipeline between the outlet of the water supply system and the first inlet of the slurry mixing system and the pipeline between the outlet of the ash supply system and the inlet of the slurry mixing system, a connection of a pipeline between an outlet of the second centrifugal pump and an inlet of the measuring tank;
adjust a rotation speed of the second centrifugal pump according to the liquid level information in the measuring tank and a first preset measuring liquid level range, so as to transport pre-liquid sucked by the external water supply pipeline from a pre-liquid source to the measuring tank, the cementing operation instruction further carrying a pre-liquid parameter, and the pre-liquid parameter comprising the first preset measuring liquid level range; and
control a connection of a pipeline between an outlet of the measuring tank and the inlet of the plunger pump so as to transport the pre-liquid to the plunger pump.

6. The full-electric drive cementing control system according to claim 5, further comprising a pressure detection apparatus, wherein:
the pressure detection apparatus is configured to detect a discharge pressure of the plunger pump; and
the control assembly is further configured to:
obtain, before controlling the connection of the pipeline between the outlet of the second centrifugal pump and the inlet of the measuring tank, the discharge pressure of the plunger pump which is measured by the pressure detection apparatus; and
adjust, if the discharge pressure of the plunger pump does not reach a preset pressure test value, the driving motor according to a difference between the discharge pressure of the plunger pump and the preset pressure test value until the discharge pressure of the plunger pump reaches the preset pressure test value, the cementing operation instruction further carrying a pressure test parameter, and the pressure test parameter comprising the preset pressure test value.

7. The full-electric drive cementing control system according to claim 5, wherein the control assembly is further configured to:
control, after controlling the driving motor to drive the plunger pump according to the preset perfusion parameter, a connection of the pipeline between the outlet of the second centrifugal pump and the inlet of the measuring tank;
adjust a rotation speed of the second centrifugal pump according to the liquid level information in the measuring tank and a second preset measuring liquid level range, so as to transport displacing liquid sucked by the external water supply pipeline to the measuring tank, the cementing operation instruction further carrying a displacing liquid parameter, and the displacing liquid parameter comprising the second preset measuring liquid level range; and
control a connection of a pipeline between an outlet of the measuring tank and the inlet of the plunger pump so as to transport the displacing liquid to the plunger pump.

8. The full-electric drive cementing control system according to claim 1, wherein the control assembly is further configured to:
control, after controlling the driving motor to drive the plunger pump to work according to the preset perfusion parameter, a connection of a pipeline between the outlet of the water supply system and an inlet of a target cleaning object so as to clean the target cleaning object by water injection, the target cleaning object comprising the plunger pump and/or the slurry mixing system;
obtain a liquid density in the target cleaning object; and
control, if the liquid density is less than or equal to a preset density threshold, a disconnection of the pipeline between the water supply system and the inlet of the target cleaning object, the cementing operation instruction further carrying a cleaning parameter, and the cleaning parameter comprising the preset density threshold.

9. The full-electric drive cementing control system according to claim 1, wherein the control assembly comprises a processor and a frequency converter, the processor being electrically connected to the driving motor, the water supply system, the ash supply system, and the slurry mixing system through the frequency converter.

10. The full-electric drive cementing control system according to claim 1, further comprising an operation display, wherein:
the operation display is electrically connected to the control assembly;
the control assembly is further configured to obtain an operation parameter of a target monitoring object, determine whether the target monitoring object is abnormal according to the operation parameter, and transmit, if the target monitoring object is abnormal, warning prompt information to the operation display, the target monitoring object comprising one or more of the driving motor, the plunger pump, the water supply system, the ash supply system, and the slurry mixing system; and
the operation display is configured to receive and display the warning prompt information transmitted by the control assembly.
